(19) United States
(12) Patent Application Publication
(10) Pub. No.: US 2011/0169706 A1
(43) Pub. Date: Jul. 14, 2011

(54) ANTENNA DEVICE AND METHOD

(75) Inventor: Marcus Maria Petrus Gerardus Wintels, Duivendrecht (NL)

(73) Assignee: CYNER SUBSTRATES B.V., Utrecht (NL)

(21) Appl. No.: 12/865,601

(22) PCT Filed: Jan. 30, 2009
(86) PCT No.: PCT/NL2009/050048

§ 371 Date: Nov. 22, 2010

(30) Foreign Application Priority Data
Jan. 30, 2008 (NL) 2001238
Aug. 29, 2008 (NL) 2001938

(51) Int. Cl. H01Q 1/22; H01P 11/00

(52) U.S. Cl. 343/720; 29/601

(57) ABSTRACT

An antenna device includes an antenna element for exchanging electromagnetic radiation, in particular radio frequency radiation, with a surrounding area. The antenna element herein includes a first conductor element (11) on a first substrate (10) and a second conductor element (21) on a second substrate (20). The first and second substrate form part of a stack of layers, wherein at least one connecting electrode of the at least one antenna element is coupled for electrical conduction to an electric port of an electro-optical converter. The electro-optical converter is arranged at least partially on a layer of the stack.

The present invention relates to an antenna device comprising at least one antenna element for exchanging electromagnetic radiation, in particular radio frequency radiation, with a surrounding area, which antenna element comprises a first conductor element on a first electrically insulating substrate and a second conductor element on a second electrically insulating substrate, wherein both said conductor elements are separated from each other by a dielectric. The invention also relates to a method for manufacturing such an antenna device.

An antenna device of the type described in the preamble substantially comprises a stack of a number of flat layers, normally referred to as a microstrip patch antenna (MPA), and is advantageously applied as flat antenna, particularly as phased array antenna, for aircraft and vehicles wherein a profile of the antenna must preferably lie as flush as possible with a wall. A phased array antenna has an antenna device with a large number of antenna elements which are ordered in a regular structure and controlled individually or in groups by means of control electronics adapted for the purpose in order to effect a specific desired directional operation of the overall antenna. This is particularly important in mobile applications, wherein an optimal signal transfer can be realized by keeping the antenna always targeted at a specific transmitter or receiving station.

Owing to the increased use of mobile telephony, internet and mobile e-mail traffic there is an increasing need for a broadband mobile telecommunication solution, particularly on board aircraft. Frequency bands are available for such communication in a range of several to several tens of gigahertz, wherein sufficient bandwidth appears to be available for the time being to provide for present and future telecommunication requirements. For an effective and efficient signal transfer an antenna of the type stated in the preamble preferably has between the two conductor elements a dielectric with a permittivity equal to that of a vacuum, or a relative dielectric constant or permittivity at least substantially equal to one. Many gases in particular fulfil this condition in practice, although solid materials usually have a permittivity which is factors higher than this.

Such an antenna device is known from European patent application EP 596.618, wherein between the first and second substrate an aerated foam layer is applied as dielectric, in particular of synthetic foam with a high dielectric constant. Owing to the relatively large proportion of air in such a foam layer the relative dielectric constant thereof is close to that of air, or about one. Although a desired relative permittivity can hereby be achieved per se, it is found to be far from constant in the known antenna device. Instead the dielectric constant of the dielectric fluctuates to a considerable degree in an antenna element as well as between antenna elements in this known antenna device, whereby it is less suitable for demanding applications such as ultrahigh-frequency signal transfer for telecommunication purposes.

In order to moreover preclude mutual interference between individual antenna elements as far as possible, galvanic wire tracks must lie at a minimum mutual pitch depending on the occurring signal levels and frequencies. In the known antenna device this ultimately reduces the packing density, whereby the minimum dimensions of the device will increase. Not only does the final fitting of the device hereby require more space, more importantly an enlarged substrate area also results in a process control which is more difficult to control and, in the extreme case, in increased production wastage.

The present invention has for its object, among others, to provide an antenna device with which a high packing density can be achieved in that galvanic crosstalk of individual antenna elements is effectively prevented.

In order to achieve the stated object an antenna device of the type described in the preamble has the feature according to the invention that the first and second substrate form part of a stack of layers, that at least one connecting electrode of the at least one antenna element is coupled for electrical conduction to an electric port of an electro-optical converter, and that the electro-optical converter is arranged at least partially on a layer of the stack of layers. An optical signal transfer is possible from the electro-optical converter via transmission tracks (fibres) which are provided for this purpose and which, just as the converters themselves, can be integrated on the substrate. Such an optical signal transfer is insensitive to electromagnetic interference, so that it is not necessary to take into account crosstalk between conductor tracks. Furthermore, the device according to the invention is thus also less sensitive to external interference.

The present invention further has for its object, among others, to provide an antenna device type with a dielectric which has a permittivity which comes close to that of vacuum and which is moreover at least substantially uniform over the whole antenna device. A particular embodiment of the antenna device of the type according to the invention described in the preamble has for this purpose the feature that the first and the second substrate comprise the conductor elements on their mutually facing sides and are separated from each other by an electrically insulating intermediate layer, and that at least at the position of the two conductor elements the intermediate layer leaves clear a window inside which the conductor elements fit at least substantially completely.

In the final device the window thus forms between the two conductor elements an (air) chamber with the desired low relative permittivity in order to enable an optimum signal exchange. Other than in the known antenna device, the dielectric constant of the dielectric in the device according to the invention is absolutely, or at least for the most part, constant in an antenna element per se as well as between individual antenna elements. The invention is herein based on the insight that the foam layer of the known device is arranged between the two substrates by adhesion with a suitable adhesive and that the adhesive applied here fills pores in the foam layer to a greater or lesser extent. The dielectric constant of this dielectric will therefore inevitably be affected by a measure of penetration of the adhesive into the foam layer which cannot be estimated and controlled, and can thereby fluctuate strongly in an antenna element as well as between antenna elements. Because the dielectric is formed by an empty chamber in the antenna device according to the invention, such uncontrollable process variations are avoided therein and a uniform relative permittivity of the dielectric in the device is guaranteed.

Diverse materials are per se suitable for the insulating intermediate layer and the substrates. A preferred embodiment of the antenna device according to the invention has the feature however that said substrates and the intermediate layer comprise an integral body of a dense material chosen from a group comprising plastics, ceramic materials and glass. A further embodiment of the antenna device according to the invention more particularly has the feature that the intermediate layer and the first substrate are formed from a plastic, in particular polytetrafluoroethylene (PTFE), and that the second substrate comprises a ceramic layer, in particular a glass fibre-reinforced composite laminate. A “dense” material is here understood to mean a material with a substantially isotropic density distribution, this in contrast to for instance foamed materials which have a density which is to large extent anisotropic. Such a dense, isotropic material allows for passages to be formed therein with a smooth regular inner wall which allow a reliable metal covering with a highly controllable impedance. Other than a material with an open structure or with pores, such as a foam layer, this therefore provides the option of forming metallized transverse passages therein, also referred to as “vias”, which can be used to connect conductor elements or other electronic parts to or via different levels of the antenna device. A relatively high packing density can hereby be achieved. PTFE and ceramic moreover possess extremely good dielectric and mechanical properties for use in the device according to the invention.

For the purpose of an electrical coupling of the conductor elements a further particular embodiment of the antenna device according to the invention has the feature that at least one first connecting electrode is provided on a side of the second substrate remote from the second conductor element. A further particular embodiment of the antenna device according to the invention is more particularly characterized here in that the at least one first connecting electrode comprises an earth electrode. The at least one connecting electrode, or earth electrode, is thus arranged at a separate level in the device which, in addition to a great freedom of design, also enables an increased packing density. A further particular embodiment of the antenna device according to the invention has the feature that the second substrate lies on a third electrically insulating substrate which comprises at least one second connecting electrode on a side remote from the second substrate, and more particularly that the at least one second connecting electrode comprises at least one signal electrode. The same advantages apply here mutatis mutandis for the at least one second connecting electrode, or signal electrode.

With a view to a compact integration of the individual conductive parts of the device in the thus obtained layered structure, a further preferred embodiment of the antenna device according to the invention has the feature that at least one connecting electrode, in particular a signal electrode, is connected for electrical conduction to a conductor element of the antenna element via a continuous cavity in at least one intermediate substrate. Such transverse passages can be realized at any desired location in the device in order to make electrically conductive connections between different layers of the device. This provides very great freedom of design, resulting ultimately in an increased packing density. Such interlateral connections are not only possible via the first and second substrate with the intermediate layer therebetween, but can also be made via said third substrate or optional further substrates of the device. For this and other purposes a further particular embodiment of the antenna device according to the invention has the feature that the third substrate comprises an integral body of a dense material chosen from a group comprising plastics, ceramic materials and glass, in particular of a plastic such as polytetrafluoroethylene (PTFE). The dense, at least substantially isotropic material of the third substrate here also provides the option of forming passages therein with a reliable metal covering, and thereby a readily controllable impedance. A material such as PTFE also has excellent dielectric and mechanical properties for this purpose. In order to disrupt the dielectric properties in the antenna element as little as possible here, a further particular embodiment of the antenna device according to the invention herein has the feature that the third substrate leaves clear at the position of the first and second conductor element a second window within which both conductor elements also fit at least substantially completely, at least in projection.

Owing to its relatively flat, layered structure the antenna device according to the invention is highly suitable for a flat fitting against an outer wall of an object, such as particularly an aircraft or other means of transport. An outer shell thereof is often formed from sheet metal material and does not therefore allow below-skin fitting. It is therefore necessary in practice to resort to surface mounting. For the purpose of an adequate insulation and disconnection of the antenna element from such a surface, a further particular embodiment thereof has the feature according to the invention that the third substrate rests on at least one further electrically insulating substrate which, at the position of the first and second conductor element, leaves clear a third window within which both conductor elements also fit at least substantially completely, at least in projection.

Also possible via the at least one further substrate are transverse connections which contribute toward a compact wiring circuit for the purpose of contact between the different components. With a view hereto, a further preferred embodiment of the antenna device according to the invention has the feature that at least one of the at least one further substrate comprises at least one continuous transverse cavity having a conductor track therein for contact with at least one connecting electrode of the at least one antenna element, and more particularly that the at least one further substrate comprises an integral body of a dense material chosen from a group comprising plastics, ceramic materials and glass, in particular of a plastic such as polytetrafluoroethylene (PTFE). The design freedom grows with the number of further substrates. In addition to the desired permittivity, PTFE here also ensures excellent mechanical properties, this resulting in an extremely robust, shock and impact-resistant whole.

The optical signals are advantageously processed by optical processing means. To this end a further particular embodiment of the antenna element according to the invention has the feature that an optical port of the electro-optical converter is coupled to an optical port of an optical processing device, and more particularly that the optical processing device is arranged at least partially on at least one of said substrates.

The antenna device according to the invention is particularly suitable as phased array antenna which, making use of suitable processing means, can be given a variable directional sensitivity. With a view hereto, a further particular embodiment of the antenna device according to the invention has the feature that a number of individual antenna elements is provided therein having in each case a window in the intermediate layer between the first and the second conductor element of the relevant antenna element, and more particularly that the antenna elements are ordered in a matrix of n by m elements, wherein n and m represent a whole number greater than one and zero respectively. An exceptionally compact structure is obtained here in a further particular embodiment wherein the antenna element according to the invention is characterized in that the antenna elements have a shared earth electrode and are each provided with at least one individual signal electrode connected for electrical conduction to one of the two conductor elements of the relevant antenna element. In order to enable targeting and/or forming of a radiation pattern around the antenna as required, a further particular embodiment has the feature here that the antenna elements are each provided with two separate individual signal electrodes. Using the two signal electrodes a polarization can be imparted to the radiation pattern, adapted for instance to a specific desired directional sensitivity of the device.

A method for manufacturing an antenna device with at least one antenna element comprising a first and a second conductor element with a dielectric therebetween has the feature according to the invention that a first substrate is provided with at least one first conductor element, that a second substrate is provided with at least one second conductor element, that an intermediate layer is provided with at least one window of lateral dimensions greater than those of said conductor elements, that said substrates are joined together with interposing of the intermediate layer while said conductor elements and said window are aligned to one another, and that the intermediate layer and said substrates are durably connected to each other. A particular embodiment of the method according to the invention has the feature here that a third substrate is provided on either side with at least one connecting electrode for the antenna element, that the third substrate is provided with a second window in line with the window in the intermediate layer, and that the third substrate is joined together with the other said substrates and the intermediate layer to form a whole mutually connected in durable manner. By thus making use of a number of individual substrate bodies with the conductor elements thereon, or one or more windows therein, the different parts can be handled in practical manner and produced as semi-manufacture prior to their mutual assembly. A relatively simple and readily controllable stacking will then suffice to join the parts together to form one whole.

A particular embodiment of the method according to the invention has the feature here that at least one further substrate is provided with at least one further window in line with the window in the intermediate layer, and that the at least one further substrate is joined together with the other said substrates and the intermediate layer to form a whole mutually connected in durable manner. A mounting base is thus provided via which a mutual wiring of the individual conductive components is possible and the device can be arranged integrally on a surface.

Exceptionally good and reliable results have been achieved in a preferred embodiment of the method according to the invention characterized in that said substrates and intermediate layer are pressed onto each other with interposing of a suitable adhesion at increased temperature and pressure in a single process run. Prior to this pressing together the parts are aligned precisely relative to each other, for instance making use of a jig. The subsequent pressing together and mutual adhesion of the individual parts can thus be performed with sufficient precision and with high durability. A particular embodiment of the method according to the invention has the feature here that for said substrates and intermediate layer use is made of an integral body of a dense material chosen from a group comprising plastics, ceramic materials and glass, in particular of a plastic such as polytetrafluoroethylene (PTFE).

The invention will be further elucidated hereinbelow on the basis of an exemplary embodiment and an associated drawing. In the drawing:

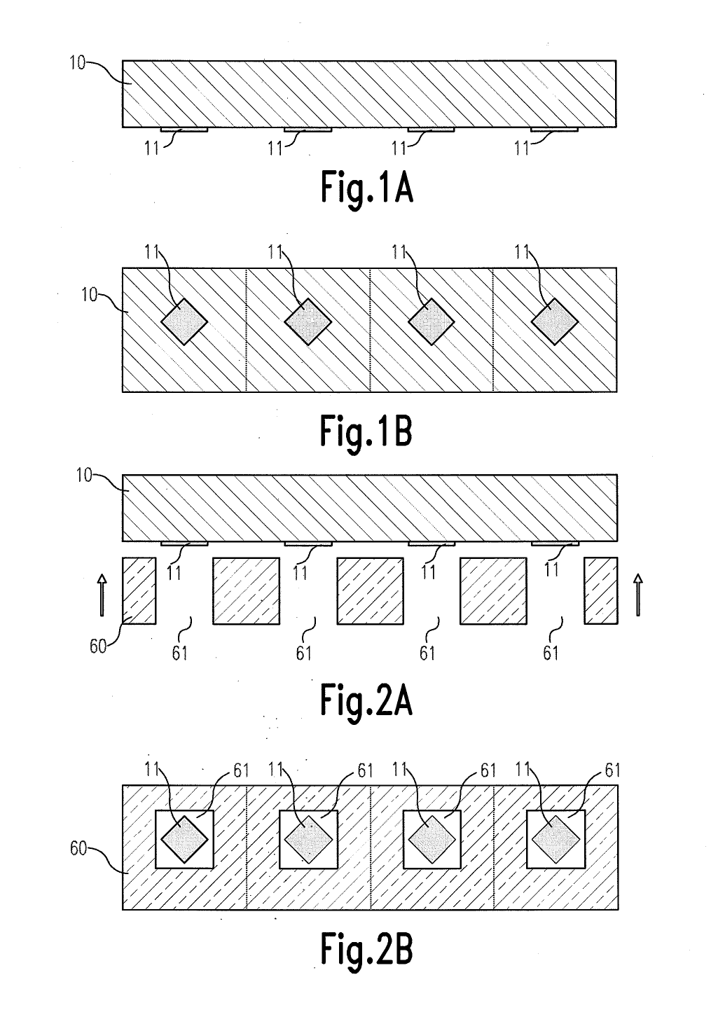

FIGS. 1A-5B show a first exemplary embodiment of an antenna device according to the invention at successive stages of manufacture in accordance with an exemplary embodiment of a method according to the invention, wherein
figure A shows in each case a cross-section and figure B a top view; and

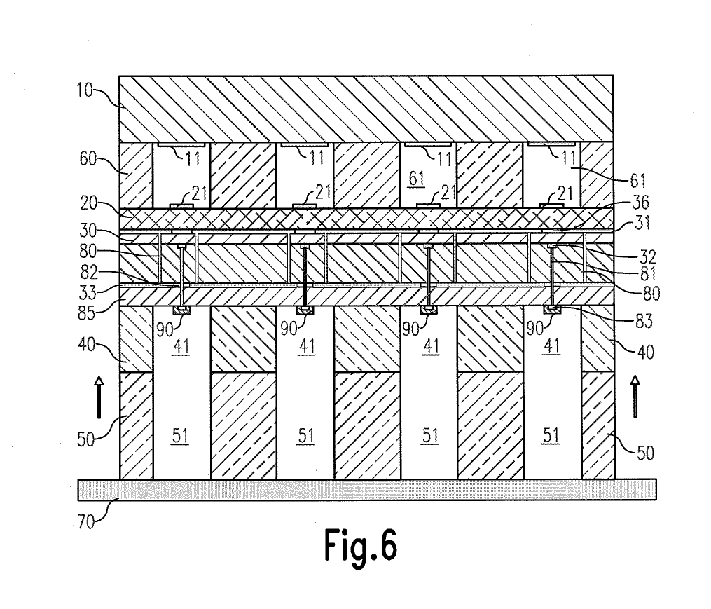

FIG. 6 shows a cross-section of a second exemplary embodiment of an antenna device according to the invention.

The figures are otherwise purely schematic and not drawn to scale. Some dimensions in particular may be exaggerated to a greater or lesser extent for the sake of clarity. Corresponding parts are designated in the figures with the same reference numeral.

For the purpose of manufacturing an exemplary embodiment of an antenna device according to the invention use is made in this exemplary embodiment of the method according to the invention of a first insulating substrate 10, see FIG. 1, which is fully metallized on one side with a thin metal layer 11. For substrate 10 in this example use is advantageously made of a dense material, i.e. with substantially isotropic density distribution, having the desired dielectric properties. Substrate 10 here more specifically comprises a layer of polytetrafluoroethylene (PTFE) which is about 1 to 2 millimetres thick and has thereon a copper layer 11 which is about 10-20 μm thick. The copper layer is arranged in a pattern of a number of discrete first conductor elements 11, as shown in FIGS. 1A and 1B, by masking and etching making use of suitable photolithographic techniques. The conductor elements can in principle be of any design, although a choice is made here for a roughly square embodiment of about 5-10 by 5-10 millimetres. Conductor elements 11 correspond to four individual antenna elements which are thus realized in a 4×1 matrix as indicated schematically with broken lines in the elevation figures. Using the method described here however, any matrix, smaller or larger, or other arrangement of antenna elements can in principle be realized, and an antenna element can also be manufactured as discrete component.

Arranged on the first substrate is an intermediate layer 60, see FIG. 2A, in which windows 61 corresponding to the locations of the first conductor elements 11 have been preformed. Windows 61 are roughly square, see FIG. 2B, with sides of about 10-15 millimetres and thereby sufficiently largely dimensioned to wholly receive the conductor elements therein. In this example a plastic, such as particularly PTFE, has also been chosen for the intermediate layer, wherein use is also made of a thickness in the order of about 1 to 2 millimetres. The windows can be arranged therein in various ways, such as for instance by means of (laser) cutting or precision punching.

A second insulating substrate 20 is arranged on intermediate layer 60, see FIG. 3A. Use is also made for the second substrate of a dense, substantially isotropic material, wherein in this case a layer of glass fibre-reinforced carbon composite has been chosen with a thickness in the order of several tenths of a millimetre up to a millimetre. This ceramic material is commercially available and has the desired dielectric properties. Second substrate 20 is also metallized on one side with a copper layer about 10-20 μm thick from which a pattern is formed of a number of discrete second conductor elements 21 opposite the first conductor elements 11. As for the first conductor elements 11, use is made for the second conductor elements in this example of a square design, see FIG. 3B, albeit that the dimensions with sides in the order of 3-5 millimetres are smaller than in the case of the first conductor elements 11.

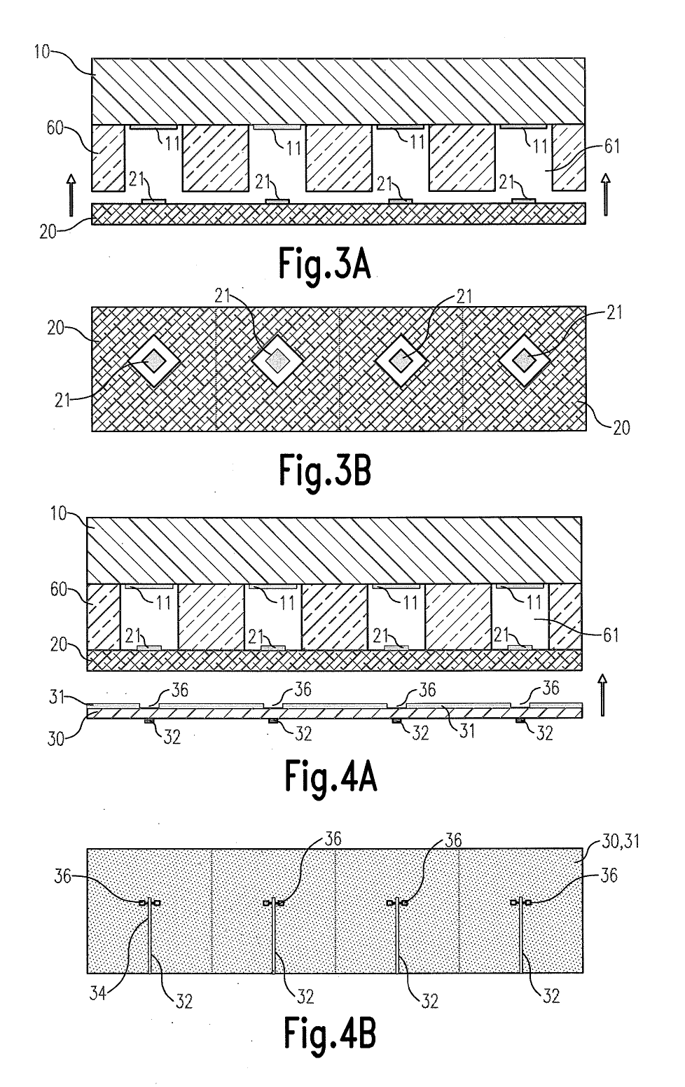

The whole is joined together with a third insulating substrate 30, see FIG. 4A, which is provided on a facing side with a first connecting electrode 31 and on the opposite side per antenna element with at least one second connecting electrode 32. The first connecting electrode is an earth electrode in the final device and is shared by the antenna elements forming part of the device. The second connecting electrodes 32 form signal electrodes and carry a reception signal or transmission signal. When the device will be applied simultaneously for both transmitting and receiving, at least two of such signal electrodes 32 are provided per antenna element. Third substrate 30 is formed from a dense plastic such as PTFE and has a relatively small thickness in the order of 200-300 μm. Partly for this reason it is possible in relatively simple manner to realize therein at the position of the second connecting electrodes 32 vertical transverse passages which are filled with a suitable metallized material in order to realize vertical conductor tracks in the device.

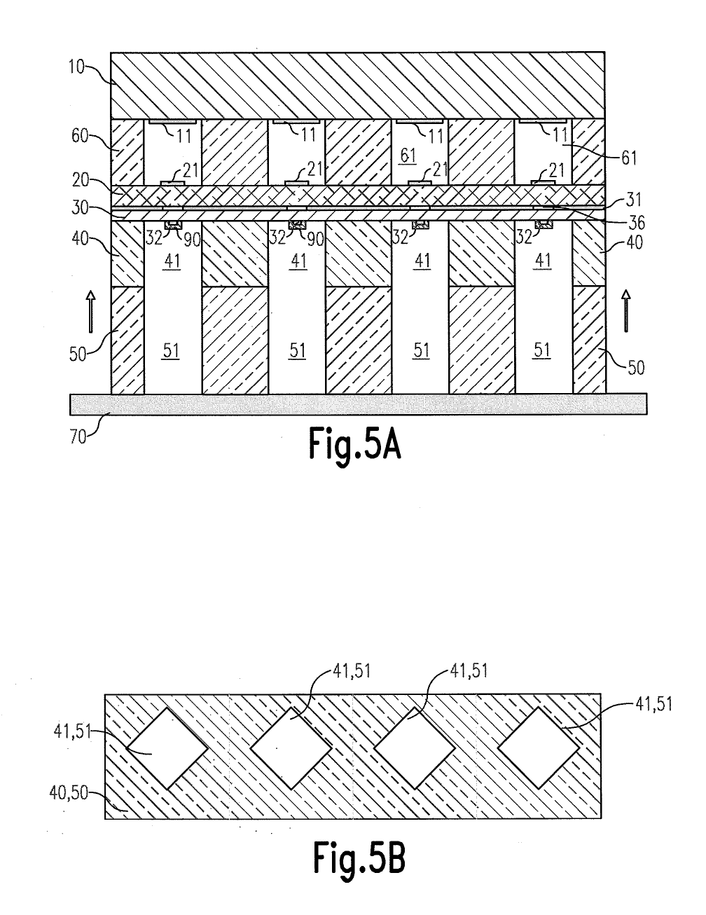

Earth electrode 31 leaves clear so-called dog-bone windows 36, see FIG. 4B, for the purpose of the desired electrodynamic properties of the final antenna device. The thus coated third substrate 30 is joined together under pressure with the other part of the device to form the whole shown in FIG. 5A. Signal electrodes 32 are thus individually AC connected to second conductor elements 21 of the relevant antenna element.

For the purpose of a practical mounting base and finishing of the whole, a first further substrate 40 and second further substrate 50 are arranged successively on third substrate 30. These further substrates 40,50 are both manufactured from a dense plastic such as PTFE with a thickness of respectively about 30-35 and 10-20 millimetres. Before joining the further substrates to the other part of the device, windows 41,51 are formed therein at the position of windows 61 in intermediate layer 60. These additional windows 41,51 can for instance be arranged by (laser) cutting or precision punching, and provide for an effective disconnection of the antenna elements from a surface.

Owing to the mutual layered structure wiring layers can be provided between further substrates 40,50 for contact with the antenna elements, and further electronic components can also be integrated therein, such as for instance galvanic conductor tracks, electro-optical converters, optical conductor tracks, optical switching elements and other possible processing electronics. The antenna device can thus be embodied as active component in which a possible signal processing and adjustment and control of the antenna elements can be dealt with wholly or partially on board. An exemplary embodiment hereof is shown in FIG. 6.

The exemplary embodiment of FIG. 6 is largely similar to that of FIG. 5, except that in the device of FIG. 6, owing to the layered nature of the structure, several additional insulating intermediate layers 85,86 have been added in relatively simple manner with additional wiring layers 33, 83 therebetween and thereon. The additional intermediate layers 85,86 comprise a relatively dense, isotropic plastic such as PTFE and thus allow vertical galvanic passages 80,81 with a strictly controlled impedance to be provided therein for mutual galvanic connection of different wiring levels. Wiring layer 33 serves to carry away connecting electrodes 31 connected to earth. Provided therebetween for this purpose is a vertical metallized material 80 with a controlled impedance. Signal electrode 32 can be contacted with the other wiring layer 83, whereby a reception or transmission signals can be provided. A vertical metallized material 81 with a controlled impedance here also provides a galvanic coupling. At the position of these vertical passages 81 windows 82 are provided in wiring layer 33 connected to earth in order to avoid short-circuit.

A problem of relatively large arrays in a device according to the prior art is the accommodating of the signal lines to a processing unit. Depending on the space of an individual wiring including insulation, only a limited number of antenna elements can be contacted via a single wiring layer. The more elements there are, the more substrate area is required therefor. In the device according to the invention it is however possible to resort for this purpose to wiring layers at different levels, whereby the substrate area, or so-called “footprint” of the device, can remain limited. For an array with 1600 elements the structure of FIG. 6 could in practice be enlarged to for instance the order of ten layers in order to accommodate all wire tracks. This is the case if the wire tracks are guided to a periphery of the device with the intention of there making connections to a processing unit. According to the invention however, a coupling to the data processing unit can also take place directly or substantially directly under an element, thereby at least largely solving this problem since the wire tracks then take up hardly any space. The antenna element remains clear on a top side so as to ensure the best possible undisturbed signal exchange with the surrounding area at that position. On the underside the cavities 41,51 provide space for such a local contact. An additional advantage of such a setup is that an optionally optical connection can be realized here in cavities 41,51 which is disconnected from a surface, such as for instance an aircraft skin, on which the device is ultimately mounted.

For the purpose of the above mounting, among others, the whole is closed with a mounting flange 70 of aluminium or other suitable material with which the device can be arranged at the intended position on a surface (substrates). Once the individual components have been joined together with interposing of a suitable adhesion and accurately aligned in the manner described above and indicated by arrows, the thereby obtained stack is pressed together at increased temperature and pressure, whereby a robust, durably connected whole is obtained which can be immediately applied.

Although the invention has been further elucidated above on the basis of only a single exemplary embodiment, it will be apparent that the invention is by no means limited thereto. On the contrary, many variations and embodiments are still possible for a person with ordinary skill in the art within the scope of the invention.

1. Antenna device comprising at least one antenna element for exchanging electromagnetic radiation, in particular radio frequency radiation, with a surrounding area, which antenna element comprises a first conductor element on a first electrically insulating substrate and a second conductor element on a second electrically insulating substrate, wherein both said conductor elements are separated from each other by a dielectric, characterized in that the first and second substrate form part of a stack of layers, that at least one connecting electrode of the at least one antenna element is coupled for electrical conduction to an electric port of an electro-optical converter, and that the electro-optical converter is arranged at least partially on a layer of the stack of layers.

2. Antenna device as claimed in claim 1, characterized in that an optical port of the electro-optical converter is coupled to an optical port of an optical processing device.

3. Antenna device as claimed in claim 2, characterized in that the optical processing device is arranged at least partially on at least one of said substrates.

4. Antenna device as claimed in claim 1, characterized in that a number of individual antenna elements is provided therein having in each case a window in the intermediate layer between the first and the second conductor element of the relevant antenna element.

5. Antenna device as claimed in claim 4, characterized in that the antenna elements are ordered in a matrix of n by m elements, wherein n and m represent a whole number greater than one and zero respectively.

6. Antenna device as claimed in claim 4, characterized in that the antenna elements have a shared earth electrode and are each provided with at least one individual signal electrode connected for electrical conduction to one of the two conductor elements of the relevant antenna element.

7. Antenna device as claimed in claim 6, characterized in that the antenna elements are each provided with two separate individual signal electrodes.

8. Antenna device as claimed in claim 1, characterized in that the first and the second substrate comprise the conductor elements on their mutually facing sides and are separated from each other by an electrically insulating intermediate layer, and that at least at the position of the two conductor elements the intermediate layer leaves clear a window inside which the conductor elements fit at least substantially completely.

9. Antenna device as claimed in claim 8, characterized in that said substrates and the intermediate layer comprise an integral body of a dense material chosen from a group comprising plastics, ceramic materials and glass.

10. Antenna device as claimed in claim 9, characterized in that the intermediate layer and the first substrate are formed from a plastic, in particular polytetrafluoroethylene (PTFE), and that the second substrate comprises a ceramic layer, in particular a glass fibre-reinforced composite laminate.

11. Antenna device as claimed in claim 1, characterized in that at least one first connecting electrode is provided on a side of the second substrate remote from the second conductor element.

12. Antenna device as claimed in claim 11, characterized in that the at least one first connecting electrode comprises an earth electrode.

13. Antenna device as claimed in claim 11, characterized in that the second substrate lies on a third electrically insulating substrate which comprises at least one second connecting electrode on a side remote from the second substrate.

14. Antenna device as claimed in claim 13, characterized in that the at least one second connecting electrode comprises at least one signal electrode.

15. Antenna device as claimed in claim 13, characterized in that at least one connecting electrode, in particular a signal electrode, is connected for electrical conduction to a conductor element of the antenna element via a continuous cavity in at least one intermediate substrate.

16. Antenna device as claimed in claim 13, characterized in that the third substrate comprises an integral body of a dense material chosen from a group comprising plastics, ceramic materials and glass, in particular of a plastic such as polytetrafluoroethylene (PTFE).

17. Antenna device as claimed in claim 13, characterized in that the third substrate leaves clear at the position of the first and second conductor element a second window within which both conductor elements also fit at least substantially completely, at least in projection.

18. Antenna device as claimed in claim 17, characterized in that the third substrate rests on at least one further electrically insulating substrate which, at the position of the first and second conductor element, leaves clear a third window within which both conductor elements also fit at least substantially completely, at least in projection.

19. Antenna device as claimed in claim 18, characterized in that at least one of the at least one further substrate comprises at least one continuous transverse cavity having a conductor track therein for contact with at least one connecting electrode of the at least one antenna element.

20. Antenna device as claimed in claim 18, characterized in that the at least one further substrate comprises an integral body of a dense material chosen from a group comprising plastics, ceramic materials and glass, in particular of a plastic such as polytetrafluoroethylene (PTFE).

21. Method for manufacturing an antenna device with at least one antenna element comprising a first and a second conductor element with a dielectric therebetween, wherein a first substrate is provided with at least one first conductor element, wherein a second substrate is provided with at least one second conductor element, wherein an intermediate layer is provided with at least one window of lateral dimensions greater than those of said conductor elements, wherein said substrates are joined together with interposing of the intermediate layer while said conductor elements and said window are aligned to one another, and wherein the intermediate layer and said substrates are durably connected to each other.

22. Method as claimed in claim 21, characterized in that a third substrate is provided on either side with at least one connecting electrode for the antenna element, that the third substrate is provided with a second window in line with the window in the intermediate layer, and that the third substrate is joined together with the other said substrates and the intermediate layer to form a whole mutually connected in durable manner.

23. Method as claimed in claim 21, characterized in that at least one further substrate is provided with at least one further window in line with the window in the intermediate layer, and that the at least one further substrate is joined together with the other said substrates and the intermediate layer to form a whole mutually connected in durable manner.

24. Method as claimed in claim 21, characterized in that said substrates and intermediate layer are pressed onto each other with interposing of a suitable adhesion at increased temperature and pressure in a single process run.

25. Method as claimed in claim 21, characterized in that for said substrates and intermediate layer use is made of an integral body of a dense material chosen from a group comprising plastics, ceramic materials and glass, in particular of a plastic such as polytetrafluoroethylene (PTFE).
